(19) United States
(12) Patent Application Publication
(10) Pub. No.: US 2015/0042596 A1
(43) Pub. Date: Feb. 12, 2015

(54) TOUCH PANEL CAPABLE OF PERFORMING PROXIMITY FUNCTION AND A METHOD OF USING THE SAME

(71) Applicant: HIMAX TECHNOLOGIES LIMITED, Tainan City (TW)

(72) Inventors: Chung-Wen Chang, Tainan City (TW); Shen-Feng Tai, Tainan City (TW); Jui-Min Liu, Tainan City (TW); Li-Lin Liu, Tainan City (TW)

(73) Assignee: HIMAX TECHNOLOGIES LIMITED, Tainan City (TW)

(21) Appl. No.: 13/962,710

(22) Filed: Aug. 8, 2013

(51) Int. Cl. G06F 3/044

(52) U.S. Cl. CPC G06F 3/044
USPC 345/174

(57) ABSTRACT

A touch panel capable of performing proximity function is disclosed. A voltage is applied to column electrode or row electrode during a self scan cycle, and a capacitive object close to a surface of the touch panel is measured on the same column electrode or row electrode. A voltage is applied to one axis during a mutual scan cycle, and a capacitive object close to the surface of the touch panel is measured on the other axis.

### BACKGROUND OF THE INVENTION

1. Field of the Invention

The present invention generally relates to a touch panel, and more particularly to a touch panel capable of performing proximity function.

2. Description of Related Art

A proximity sensor is a sensor that is capable of detecting presence of nearby objects without physical contact. The proximity sensor has been ordinarily used in mobile devices, such as mobile phones, to switch off display on a touch screen when the mobile phone is placed close to an object, e.g., human ear, and to resume display on the touch screen when the mobile phone is taken away from the ear.

The proximity sensor, however, demands a considerable area on the mobile device and requires substantive manufacture process and associated cost.

For the foregoing reasons, a need has arisen to propose a novel scheme to perform proximity function in a cost-effective manner.

### SUMMARY OF THE INVENTION

In view of the foregoing, it is an object of the embodiment of the present invention, to provide a touch panel capable of performing proximity function without using a proximity sensor in order to bring down manufacture cost and make an electronic device employing the touch panel less in volume.

According to one embodiment, a touch panel capable of performing proximity function includes a plurality of row electrodes disposed along a first axis, and a plurality of column electrodes disposed along a second axis. Mutual capacitance is at every intersection of each row electrode and each column electrode, and self capacitance is at each row electrode and each column electrode. A voltage is applied to the column electrode or row electrode during a self scan cycle, and a capacitive object close to a surface of the touch panel is measured on the same column electrode or row electrode. A voltage is applied to one axis during a mutual scan cycle, and a capacitive object close to the surface of the touch panel is measured on the other axis.

### BRIEF DESCRIPTION OF THE DRAWINGS

FIG. 1 shows a schematic diagram illustrative of a touch panel according to one embodiment of the present invention;

FIG. 2 shows a schematic diagram exemplifying a series of scan frames;

FIG. 3A shows self raw data with respect to a predetermined self proximity threshold;

FIG. 3B shows mutual raw data with respect to a predetermined mutual proximity threshold;

FIG. 4 shows a schematic diagram illustrating the touch panel of FIG. 1 where at least a portion of the entire touch panel may be used as a proximity sensing region;

FIG. 5 shows a flow diagram of identifying proximity action according to one embodiment of the present invention; and

FIG. 6 shows a flow diagram of relieving proximity action according to one embodiment of the present invention.

### DETAILED DESCRIPTION OF THE INVENTION

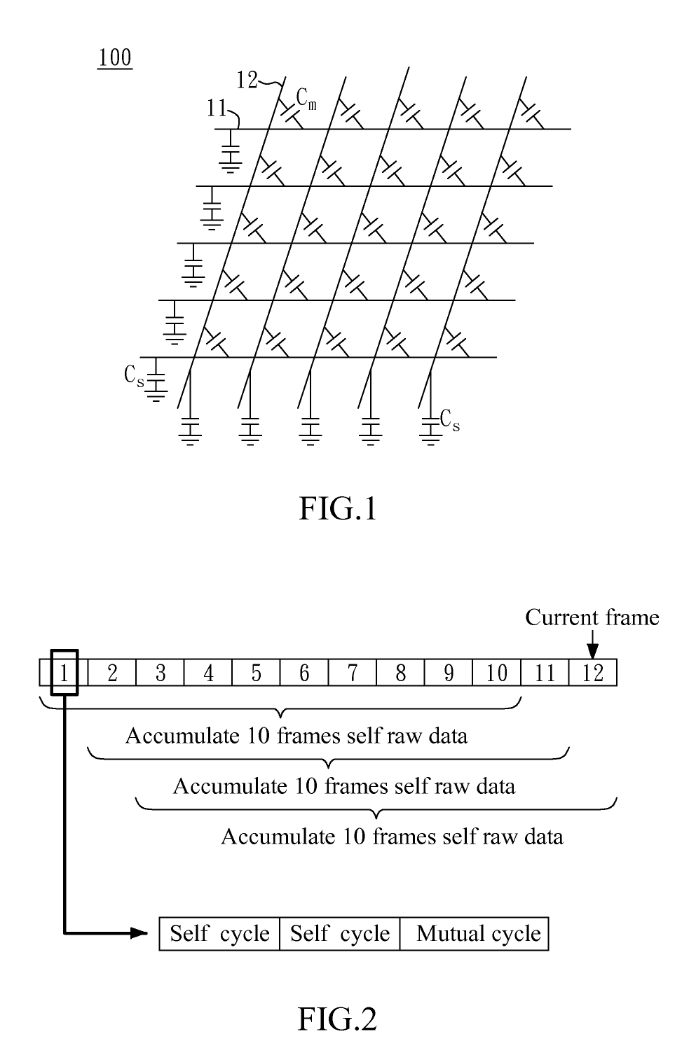

FIG. 1 shows a schematic diagram illustrative of a touch panel 100 according to one embodiment of the present invention. The touch panel 100 of the embodiment may be employed in an electronic device, such as a mobile phone. The touch panel 100, for example, a capacitive touch panel, is composed of row electrodes 11 and column electrodes 12. There is mutual capacitance Cₘ at every intersection of each row electrode 11 and each column electrode 12; and there is self capacitance Cₛ at each row electrode 11 and each column electrode 12. The touch panel 100 of the embodiment is utilized to act as a proximity sensor to perform proximity function, therefore replacing the proximity sensor that is conventionally used in touch devices. Accordingly, manufacture cost may be brought down and a touch device may be made less in volume.

Still referring to FIG. 1, regarding the self capacitance Cₛ, a voltage may be applied to the column electrode 12 or row electrode 11 during a self scan cycle, and a capacitive object close to a front (or touch) surface of the touch panel 100 may thus be measured on the same column electrode 12 or row electrode 11 by a detect circuit (not shown). Regarding the mutual capacitance Cₘ, a voltage may be applied to one axis (e.g., a column electrode 12) during a mutual scan cycle, and a capacitive object close to the touch panel 100 may thus be measured on the other axis (e.g., a row electrode 11) by the detect circuit.

FIG. 2 shows a schematic diagram exemplifying a series of scan. (or measurement) frames. According to one aspect of the embodiment, self raw data (associated with the self capacitance Cₛ) of a plurality of preceding scan frames (e.g., 10 scan frames as exemplified in FIG. 2) may be accumulated. As intensity of the self raw data is commonly weak while performing proximity sensing, the accumulation of the self raw data of the scan frames may thus enhance touch sensitivity.

According to another aspect of the embodiment, still referring to FIG. 2, a plurality of same self scan cycles (e.g., two self scan cycles as exemplified in FIG. 2) may be performed in each scan frame, and self raw data of the self scan cycles are then added. Accordingly, the added self raw data of the self scan cycles may capably enhance proximity distance (i.e., a distance measurable when a capacitive object is close to a surface of the touch panel 100).

According to a further aspect of the embodiment, still referring to FIG. 2, in addition to one or more self scan cycles performed in each scan frame, at least one mutual scan cycle is also performed in each scan frame as exemplified in FIG. 2. Mutual raw data (associated with the mutual capacitance Cₘ) of the performed mutual scan cycle may be utilized to affirm the proximity (action) identification of a capacitive object close to a surface of the touch panel 100. For example, in the embodiment, proximity identification. may be affirmed only when both proximity identifications via the self scan cycle(s) and the mutual scan cycle(s) are detected. That is, in the embodiment, failure of either self scan cycle(s) or mutual scan cycle(s) defeats the proximity identification. The performances of both the self scan cycle(s) and the mutual scan cycle(s) may be used to resist influence on the touch panel 100 due to environment change.

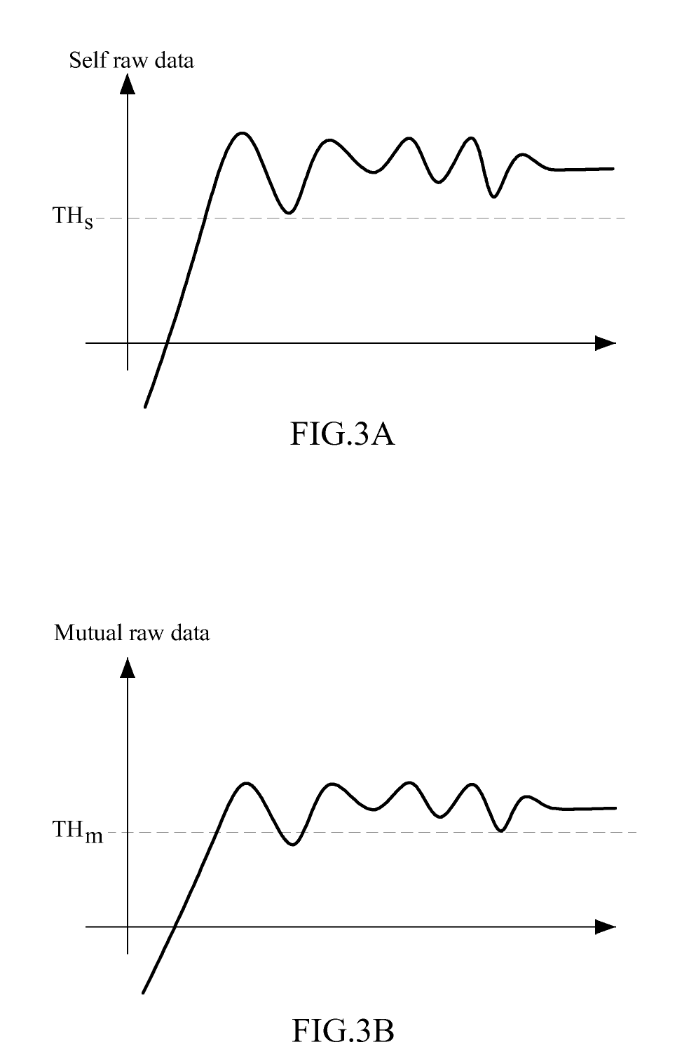

In the embodiment, regarding the self capacitance Cₛ, the proximity identification is detected when self raw data (of one or more self scan cycles in a scan frame) is greater than a predetermined self proximity threshold. THₛ (that defines a nominal range or maximum distance the touch panel 100 may detect) as illustrated in FIG. 3A. Regarding the mutual capacitance Cₘ, the proximity identification is detected when mutual raw data (of at least one scan cycle in a scan frame) is greater than a predetermined mutual proximity threshold THₘ as illustrated in FIG. 3B.

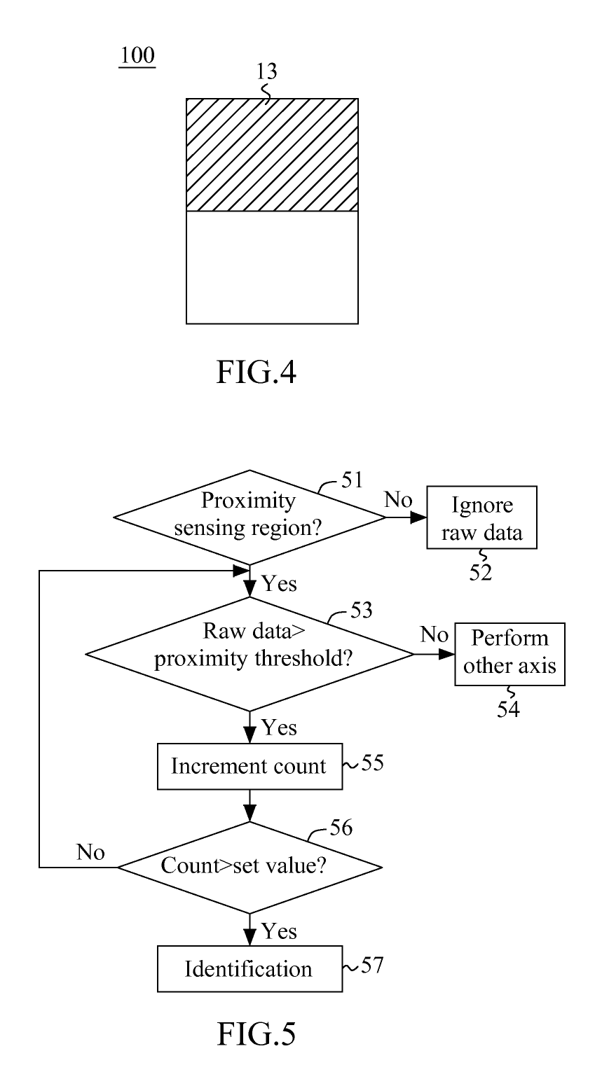

FIG. 4 shows a schematic diagram illustrating the touch panel 100 where at least a portion (e.g., one or more row electrodes 11 as exemplified in the figure) of the entire touch panel 100 may be used as a proximity sensing region 13. Alternatively, in another example (not shown), one or more column electrodes 12 may be used as a proximity sensing region.

FIG. 5 shows a flow diagram of identifying proximity action according to one embodiment of the present invention. The shown flow may be adapted to two axes, that is, the row electrodes 11 and the column electrode 12, respectively. In step 51, it is determined whether at least one (row or column) electrode 11/12 is configured to be in a proximity sensing region. If the result of step 51 is negative, collected (self or mutual) raw data of the same axis is ignored (step 52); otherwise, in step 53, the raw data is compared with a corresponding (self or mutual) proximity threshold. If the result of step 53 is negative, the flow of FIG. 5 is performed with respect to the other axis (step 54); otherwise, in step 55, a count value is incremented. When the count value is not greater than a predetermined set value (a No branch of step 56), the flow goes back to step 53 for processing a succeeding scan frame. When the count value exceeds the predetermined set value (a Yes branch of step 56), a proximity action is thus identified (step 57). As exemplified in FIG. 3A or FIG. 3B, the use of the count value in companion with the set value may prevent, false proximity identification due to spurious raw data. In the embodiment, according to the flow of FIG. 5, proximity action is affirmatively identified only when the raw data becomes stable, that is, a predetermined times of larger-than-proximity-threshold raw data has been met.

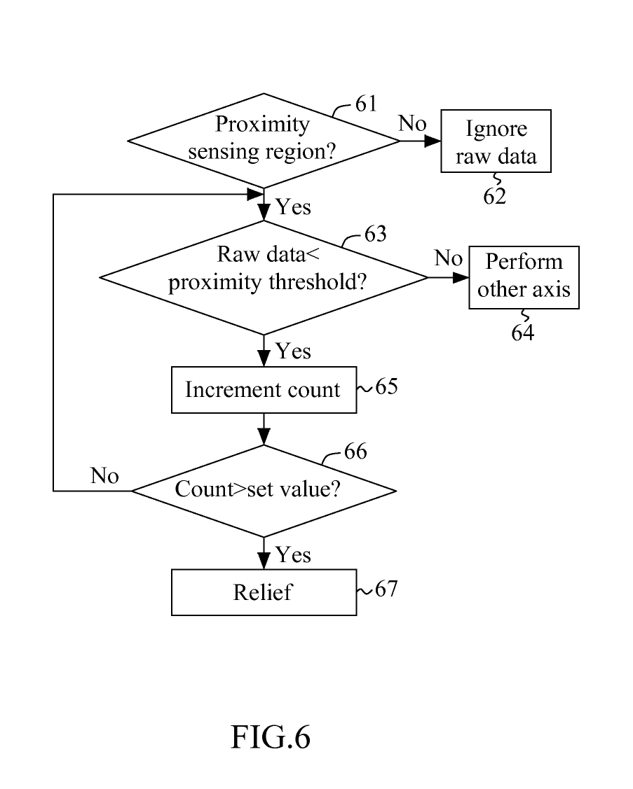

FIG. 6 shows a flow diagram of relieving proximity action (from a current identified proximity action) according to one embodiment of the present invention. The shown flow may be adapted to two axes, that is, the row electrodes 11 and the column electrode 12, respectively. In step 61, it is determined whether at least one (row or column) electrode 11/12 is configured to be in a proximity sensing region. If the result of step 61 is negative, collected (self or mutual) raw data of the other axis is ignored (step 62); otherwise, in step 63, the raw data is compared with a corresponding (self or mutual) proximity threshold. If the result of step 63 is negative, the flow of FIG. 6 is performed with respect to the other axis (step 64); otherwise, in step 65, a count value is incremented. When the count value is not greater than a predetermined set value No branch of step 66), the flow goes back to step 63 for processing a succeeding scan frame. When the count value exceeds the predetermined set value (a Yes branch of step 66), a proximity action is thus relieved (step 67). As exemplified in FIG. 3A or FIG. 3B, the use of the count value in companion with the set value may prevent false proximity relief due to spurious raw data. In the embodiment, according to the flow of FIG. 6, proximity action is affirmatively relieved only when the raw data becomes stable, that is, a predetermined, times of less-than-proximity-threshold raw data has been met.

Although specific embodiments have been illustrated and described, it will be appreciated by those skilled in the art that various modifications may be made without departing from the scope of the present invention, which is intended to be limited solely by the appended claims.

What is claimed is:

1. A touch panel capable of performing proximity function, comprising:
a plurality of row electrodes disposed along a first axis; and
a plurality of column electrodes disposed along a second axis, mutual capacitance being at every intersection of each row electrode and each column electrode, and self capacitance being at each row electrode and each column electrode;
wherein a voltage is applied to the column electrode or row electrode during a self scan cycle, and a capacitive object close to a surface of the touch panel is measured on the same column electrode or row electrode; and a voltage is applied to one axis during a mutual scan cycle, and a capacitive object close to the surface of the touch panel is measured on the other axis.

2. The touch panel of claim 1, wherein self raw data associated with the self capacitance of a plurality of preceding scan frames are accumulated.

3. The touch panel of claim 1, wherein a plurality of same self scan cycles are performed in each scan frame, and self raw data of the self scan cycles are then added.

4. The touch panel of claim 3, wherein at least one mutual scan cycle is further performed in each scan frame.

5. The touch panel of claim 4, wherein proximity identification is affirmed when both proximity identifications via the self scan cycles and the mutual scan cycle are detected.

6. The touch panel of claim 4, wherein the proximity identification is affirmed when self raw data of the self scan cycles in a scan frame is greater than a predetermined self proximity threshold, and mutual raw data of the at least one scan cycle in the scan frame is greater than a predetermined mutual proximity threshold.

7. The touch panel of claim 6, wherein at least a portion of the entire touch panel is used as a proximity sensing region.

8. The touch panel of claim 1, wherein a proximity action is affirmatively identified. when self raw data associated with the self capacitance and mutual raw data associated with the mutual capacitance become stable.

9. The touch panel of claim 1, wherein a current identified proximity action is affirmatively relieved when self raw data associated with the self capacitance and mutual raw data associated with the mutual capacitance become stable.

10. The touch panel of claim 1 is adopted in a touch device to perform proximity function without using a proximity sensor.

11. A method of using a touch panel to perform proximity function, comprising:
providing a plurality of row electrodes disposed along a first axis;
providing a plurality of column electrodes disposed along a second axis, mutual capacitance being at every intersection of each row electrode and each column electrode, and self capacitance being at each row electrode and each column electrode;
applying a voltage to the column electrode or row electrode during a self scan cycle, and a capacitive object close to a surface of the touch panel is measured on the same column electrode or row electrode; and
applying a voltage to one axis during a mutual scan cycle, and a capacitive object close to the surface of the touch panel is measured on the other axis.

12. The method of claim 11, further comprising a step of accumulating self raw data associated with the self capacitance of a plurality of preceding scan frames.

13. The method. of claim 11, further comprising:
performing a plurality of same self scan cycles in each scan frame; and
adding self raw data of the self scan cycles.

14. The method of claim 13, further comprising a step of performing at least one mutual scan cycle in each scan frame.

15. The method of claim 14, wherein proximity identification is affirmed. when both proximity identifications via the self scan cycles and the mutual scan cycle are detected.

16. The method of claim 14, wherein the proximity identification is affirmed. when self raw data of the self scan cycles in a scan frame is greater than a predetermined self proximity threshold, and mutual raw data of the at least one scan cycle in the scan frame is greater than. a predetermined mutual proximity threshold.

17. The method of claim 16, wherein at least a portion of the entire touch panel is used as a proximity sensing region.

18. The method of claim 11, wherein a proximity action is affirmatively identified when self raw data associated with the self capacitance and mutual raw data associated with the mutual capacitance become stable.

19. The method of claim 11, wherein a current identified proximity action is affirmatively relieved when self raw data associated with the self capacitance and mutual raw data associated with the mutual capacitance become stable.

20. The method of claim 11 is adopted in a touch device to perform proximity function without using a proximity sensor.
